(19) United States
(12) Patent Application Publication
(10) Pub. No.: US 2025/0323492 A1
(43) Pub. Date: Oct. 16, 2025

(54) ELECTRICAL PROTECTION DEVICE, ELECTRICAL INSTALLATION AND ASSOCIATED CONTROL METHOD

(71) Applicant: Schneider Electric Industries SAS, Rueil-Malmaison (FR)

(72) Inventors: Sébastien Heraud, Grenoble (FR); Rémy Orban, Saint Martin d'Uriage (FR); Bruno Reymond, Moirans (FR); Vincent Chauve, Colombe (FR)

(73) Assignee: Schneider Electric Industries SAS, Rueil-Malmaison (FR)

(21) Appl. No.: 19/173,272

(22) Filed: Apr. 8, 2025

(30) Foreign Application Priority Data
Apr. 10, 2024 (FR) 2403699

(51) Int. Cl. H02H 3/16; H02H 9/04

(52) U.S. Cl. CPC H02H 3/16; H02H 9/04

(57) ABSTRACT

This invention relates to an electrical protection device, comprising:
a mechanical switch;
a switching cell (18) comprising a plurality of switching modules (32, 42) comprising at least one semiconductor element (34, 35, 44, 45) and a voltage limiting element (39, 49),
   each switching module having a limiting voltage (Ulim₁, Ulim2), each switching module being configured to toggle between a conducting configuration and a blocking configuration; and
a control unit comprising a cell control module (66), configured to successively switch each switching module to the blocking configuration,
an input of the mechanical switch and an input (18a) of the switching cell, and an output of the mechanical switch and an output (18b) of the switching cell being connected to each other by a non-switchable electrical connection (19a, 19b).

### FIELD

This invention relates to an electrical protection device, an electrical installation, and an associated control method.

### BACKGROUND

It is known to use electrical protection devices comprising a mechanical switch and a switching cell comprising at least one switching module with a semiconductor element connected in parallel with a voltage limiting element. These protection devices are also called hybrid circuit breakers. US2022122801A1 describes a hybrid circuit breaker for high voltage direct current, comprising a main circuit breaker with several switching modules connected in series. When a short-circuit type fault is detected and the electrical current needs to be interrupted, the switching modules are opened successively, allowing the voltage across the main circuit breaker terminals to increase progressively and preventing deterioration of the main circuit breaker components.

However, this known hybrid circuit breaker comprises an auxiliary switch, connected in series with the mechanical switch, an assembly comprising the auxiliary switch and the mechanical switch being connected in parallel with the main circuit breaker. The auxiliary switch generates significant electrical losses, such as losses caused by heat dissipation, and increases the number of components required to implement the hybrid circuit breaker.

### SUMMARY

The aim of the invention is to propose a protection device that reduces electrical losses and limits the number of components.

To this end, the invention relates to an electrical protection device configured to be connected between a source and a load, the device comprising:
a mechanical switch configured to toggle between a closed configuration, in which the mechanical switch conducts current flowing between the source and the load, and an open configuration, in which the mechanical switch does not conduct current;
a switching cell connected in parallel with the mechanical switch, the switching cell comprising a plurality of switching modules connected to each other, each switching module comprising:
   at least one semiconductor element; and
   a voltage limiting element connected in parallel with the or each semiconductor element,
      each switching module having a limiting voltage, each switching module being configured to toggle between a conducting configuration, in which the current flows through the or one of the semiconductor elements of the switching module, and a blocking configuration, in which if the current flows through the switching module, it flows through the voltage limiting element;
a current sensor configured to measure the value of the current;
a control unit comprising:
   a detection module configured to detect a short-circuit type electrical fault based on the value of the current measured by the current sensor;
   a mechanical switch control module configured to switch the mechanical switch to the open configuration when a short-circuit type electrical fault is detected; and
   a cell control module configured to successively switch each switching module to the blocking configuration, one of the switching modules being commanded from the conducting configuration to the blocking configuration when a dielectric strength of the mechanical switch is greater than or equal to a sum of the limiting voltage of said switching module and the limiting voltages of the switching modules in the blocking configuration.

According to the invention, an input of the mechanical switch and an input of the switching cell are connected to each other by a non-switchable electrical connection, and an output of the mechanical switch and an output of the switching cell are connected to each other by a non-switchable electrical connection.

The fact that the electrical connection is non-switchable means that the device does not comprise an auxiliary switch. Thus, thanks to the invention, the number of components of the electrical device is reduced, and electrical and heat losses are minimized, improving the device's performance.

Moreover, using multiple switching modules allows the current to be limited as soon as the dielectric strength of the mechanical switch is greater than or equal to the sum of the limiting voltage of said switching module, without waiting for the dielectric strength to equal the sum of all limiting voltages. Thus, the current is limited earlier, which helps limit an increase in current caused by the short-circuit type electrical fault and therefore limits the stress on the loads or even on cables connecting the device, the source, and the load.

According to other advantageous aspects of the invention, the device comprises one or more of the following features, taken individually or in any technically possible combinations:
The switching modules are connected in series with each other.
Each switching module comprises two semiconductor elements that are unidirectional in current and connected to each other in anti-series, and for each semiconductor element, a diode is connected in anti-parallel with the semiconductor element.
The switching cell comprises two rectifying branches, the input and output of the switching cell respectively forming a midpoint of one of the rectifying branches, each rectifying branch comprising two diodes arranged on either side of the midpoint, connected in anti-series with respect to each other;
the switching modules are connected in parallel with the rectifying branches; and
each switching module comprises a single semiconductor element connected in parallel with the voltage limiting element.
The device comprises at least three switching modules.
The device further comprises a disconnector connected in series with the mechanical switch without being connected in parallel with the switching cell.
A tripping time between the detection of the short-circuit type electrical fault by the detection module and a transition of all switching modules to the blocking configuration is less than 1 ms, preferably less than 400 μs, preferably even less than 200 μs.

The invention also relates to an electrical installation comprising a source, a load connected to the source, and an electrical protection device as described hereinabove, connected between the source and the load, with a nominal voltage of the current flowing between the source and the load being less than 1500 V.

The invention also relates to a method for controlling an electrical protection device, the method comprising at least the following steps:
measurement of the value of the current by the current sensor;
detection of a short-circuit type electrical fault by the control unit, based on the value of the current measured by the current sensor;
when a short-circuit type electrical fault is detected, commanding the mechanical switch to the open configuration by the mechanical switch control module; and
successively commanding each switching module to the blocking configuration, one of the switching modules being commanded from the conducting configuration to the blocking configuration when a dielectric strength of the mechanical switch is greater than or equal to the sum of the limiting voltage of said switching module and the limiting voltages of the switching modules in the blocking configuration.

### BRIEF DESCRIPTION OF THE DRAWINGS

The invention will become clearer upon reading the following description, given solely as a non-limiting example, and made with reference to the drawings in which:

FIG. 1 is a diagram of an electrical installation comprising an electrical protection device according to a first embodiment of the invention;

FIG. 2 is a diagram of a switching cell of the electrical protection device according to the first embodiment of the invention;

FIG. 3 is a graphical representation of a voltage and current values flowing in a protection device according to the invention over time;

FIG. 4 is a flowchart of a control method according to the invention.

FIG. 5 is a diagram of a switching cell of an electrical protection device according to a second embodiment of the invention; and

FIG. 6 is a diagram of a switching cell of an electrical protection device according to a third embodiment of the invention.

### DETAILED DESCRIPTION

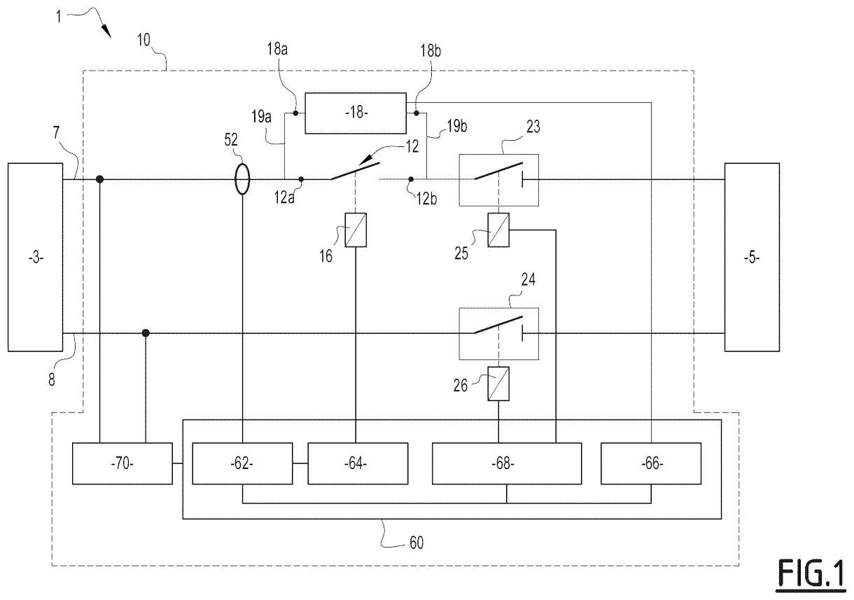

FIG. 1 is a diagram of an electrical installation 1 comprising a source 3 and a load 5, electrically connected by a phase conductor 7 and a neutral conductor 8. The source 3 supplies electricity and is, for example, an electrical generator or an electrical network, such as a mains electrical network. The load 5 is a device consuming electricity, such as a household electrical appliance, industrial equipment such as an electric motor, or a server. Thus, an electrical current, simply referred to as current hereafter, flows between the source 3 and the load 5 through the phase conductor 7 and returns to the source 3 via the neutral conductor 8.

The current is a low voltage current, meaning the current voltage is less than 1500 V. The current is alternating current or, alternatively, direct current.

The electrical installation 1 also comprises an electrical protection device 10, also referred to as the device hereafter, connected between the source 3 and the load 5. The device 10 is configured to toggle between an armed configuration, in which the device 10 conducts the current flowing between the source 3 and the load 5, and a tripped configuration, in which the device 10 electrically isolates the source 3 from the load 5.

The device 10 comprises a mechanical switch 12, also known as a bypass switch or fast mechanical switch, also called FMS (Fast Mechanical Switch). The mechanical switch 12 is connected in series with the phase conductor 7, via an input 12a and an output 12b, and is configured to toggle between a closed configuration, in which it conducts the current flowing between the source 3 and the load 5, and an open configuration, in which it does not conduct the current. In FIG. 1, the mechanical switch 12 is shown in the open configuration. The device 10 advantageously comprises an actuator 16 which, when activated, toggles the mechanical switch 12 to the open configuration.

The device 10 comprises a switching cell 18, connected in parallel with the mechanical switch 12, such that the input 12a and the output 12b of the mechanical switch 12 are connected respectively to an input 18a and an output 18b of the switching cell 18. More specifically, the input 12a of the mechanical switch 12 and the input 18a of the switching cell 18 are connected by the non-switchable electrical connection 19a, and the output 12b of the mechanical switch 12 is connected to the output 18b of the switching cell 18 by the non-switchable electrical connection 19b. In other words, the electrical connections 19a and 19b are each a cable or an electrical wire; neither of the electrical connections 19a and 19b comprises a switch or more generally a means of switching the electrical current. The switching cell 18 is configured to allow or cut-off the current passing through same, as explained hereinbelow.

The device 10 advantageously comprises a first disconnector 23 and, optionally, a second disconnector 24, connected respectively to the phase conductor 7 and the neutral conductor 8. In particular, the disconnector 23 is connected to the phase conductor 7 in series with the mechanical switch 12, without being connected in parallel with the switching cell 18. Furthermore, the disconnector 23 is connected in series with the neutral conductor 8. The disconnectors 23 and 24 are configured to toggle between a closed configuration in which the disconnectors 23 and 24 conduct the current, and an open configuration, in which the disconnectors 23 and 24 do not conduct the current. Advantageously, and as shown in FIG. 1, the device 10 comprises an actuator 25 for the first disconnector 23 and an actuator 26 for the second disconnector 24 which, when activated, interact respectively with the first disconnector 23 and the second disconnector 24 to toggle them to the open configuration. The actuators 25 and 26 are, for example, coils and are activated when a current flows through the turns of the coils.

The disconnectors 23 and 24 are configured to toggle to the open position particularly when no current flows between the source 3 and the load 5, in other words, when the current has been interrupted by the mechanical switch 12 and/or by the switching cell 18.

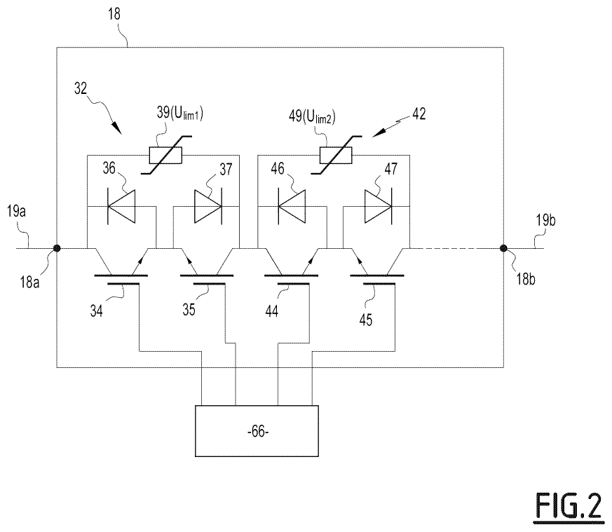

The switching cell 18 comprises a plurality of switching modules, for example, two switching modules 32 and 42, as visible in FIG. 2. Alternatively, the number of switching modules is three or more, as symbolized by the dotted line in FIG. 2.

The switching modules 32 and 42 are connected in series with each other. Each switching module 32 and 42 comprises at least one switchable semiconductor element, for example, at least one thyristor or at least one transistor, such as a field-effect transistor, also called FET (Field Effect Transistor), an insulated gate field-effect transistor, also called MOSFET (Metal Oxide Semiconductor Field Effect Transistor), an insulated gate bipolar transistor, or IGBT (Insulated Gate Bipolar Transistor), or a combination of these different semiconductor elements.

In the example of FIG. 2, each switching module 32 comprises two unidirectional current transistors 34 and 35, for example, two IGBTs. The conduction direction of the transistors 34 and 35 is indicated by an arrow on each transistor 34, 35. The transistors 34 and 35 are connected to each other in anti-series, meaning the transistors 34 and 35 are connected in series but head-to-tail, so as not to conduct the current simultaneously. Two diodes 36 and 37 are connected respectively to the transistors 34 and 35. The diode 36 is connected in anti-parallel with the transistor 34, meaning the diode 36 and the transistor 34 do not conduct the electrical current simultaneously: if the transistor 34 is conducting, the diode 36 is blocked and vice versa. In other words, the transistor 34 and the diode 36 are connected in parallel head-to-tail. The same applies to the transistor 35 and the diode 37. This arrangement allows each switching module 32 and 42 to conduct alternating current without interruption at each change of current sign.

The switching module 32 comprises a voltage limiting element 39. The voltage limiting element 39 is connected in parallel with a set formed by the transistors 34 and 35 and is, for example, a Metal Oxide Varistor, or MOV, a transil diode, or a gas discharge tube. The voltage limiting element 39 has a limiting voltage Uₗᵢₘ₁, which corresponds to a voltage across the terminals thereof when same is traversed by the current flowing between the source 3 and the load 5. It is also said that the switching module 32 has a limiting voltage Uₗᵢₘ₁.

Similarly, the switching module 42 comprises two transistors 44 and 45 and two diodes 46 and 47, similar at least functionally and connected in the same way as described for the transistors 34, 35 and the diodes 36 and 37. The switching module 42 comprises a voltage limiting element 49, similar at least functionally to the voltage limiting element 39 and connected in parallel with the transistors 44 and 45. The voltage limiting element 39 has a limiting voltage Uₗᵢₘ₂, or in other words, the switching module 42 has a limiting voltage Uₗᵢₘ₂.

The limiting voltages Uₗᵢₘ₁ and Uₗᵢₘ₂ are advantageously different, for example, the limiting voltage Uₗᵢₘ₁ is equal to 520V and the limiting voltage Uₗᵢₘ₂ is equal to 600V. Alternatively, the limiting voltages Uₗᵢₘ₁ and Uₗᵢₘ₂ are identical.

The switching modules 32 and 42 are configured to toggle between a conducting configuration and a blocking configuration. In the conducting configuration, the current flows through the switching module 32 by flowing either through the transistor 34 and the diode 37 or through the transistor 35 and the diode 36, and flows through the switching module 32 either through the transistor 44 and the diode 47 or through the transistor 45 and the diode 46. In particular, when the current passing through the device 10 is alternating, the transistor 34, the diode 37, the transistor 44, and the diode 47 conduct the current at first, then when the current changes direction, the transistor 35, the diode 36, the transistor 45, and the diode 46 conduct the current. More generally, in the conducting configuration, at least one of the transistors 34, 35 and at least one of the transistors 44, 45 conduct the current.

In the blocking configuration, the transistors 34, 35, 44, and 45 do not conduct the current, and if current flows through the switching modules 32 and 42, the current flows through the voltage limiting elements 39 and 49. Thus, in the blocking configuration, the voltage across the switching modules 32 and 42 is respectively the limiting voltage Uₗᵢₘ₁ and the limiting voltage Uₗᵢₘ₂.

The control device 10 also comprises a current sensor 52. The current sensor 52 is configured to measure a value I of the current flowing between the source and the load, and in particular the current flowing in the phase conductor 7. The current sensor 52 is, for example, a Rogowski coil.

The control device 10 comprises a control unit 60, comprising a detection module 62, connected to the current sensor 52 and configured to detect a short-circuit type electrical fault based on the value of the current I measured by the current sensor 52. Hereafter, the term short-circuit will be used to refer to a short-circuit type electrical fault.

The control unit 60 also comprises a mechanical switch control module 64, a cell control module 66, and, advantageously, a disconnector control module 68, connected to the detection module 62 and configured to control the mechanical switch 12, the switching cell 18, and the disconnectors 23 and 24 respectively.

The mechanical switch control module 64 and the disconnector control module 68 are advantageously configured to actuate respectively the actuators 16, 25, and 26, to toggle the switch 12 and the disconnectors 23 and 24 to the open configuration.

The control unit 60 is an electronic circuit designed to manipulate and/or transform data represented by electronic or physical quantities in the registers of the control unit 60 and/or memories, into similar data corresponding to physical data in the memory registers or other types of display devices, transmission devices, or storage devices.

As specific examples, the control unit 60 is implemented as a programmable logic component, such as an FPGA (Field Programmable Gate Array), or an integrated circuit, such as an ASIC (Application Specific Integrated Circuit).

In an unrepresented variant, the control unit 60 comprises an information processing unit formed, for example, of a memory and a processor associated with the memory. The detection module 62, the mechanical switch control module 64, the cell control module 66, and the disconnector control module 68 are each implemented as software, or a software block, executable by the processor. The memory of the control unit 60 is then able to store detection software, mechanical switch control software, cell control software, and disconnector control software. The processor is then able to execute each of the software among the detection software, the mechanical switch control software, the cell control software, and the disconnector control software.

In an unrepresented variant, the detection module 62, the mechanical switch control module 64, the cell control module 66, and the disconnector control module 68 are each implemented as a programmable logic component, such as an FPGA (Field Programmable Gate Array), an integrated circuit, such as an ASIC (Application Specific Integrated Circuit), or even as an analog component.

Advantageously, the device 10 also comprises a power supply module 70, connected to the conductors 7 and 8 and to the control unit 60, to supply electricity to the control unit 60. In an unrepresented variant, the power supply module 70 is connected to an external circuit, not connected to the conductors 7 and 8. In an unrepresented variant, the power supply module 70 is powered by transformer effect from the current flowing in the conductors 7 and 8.

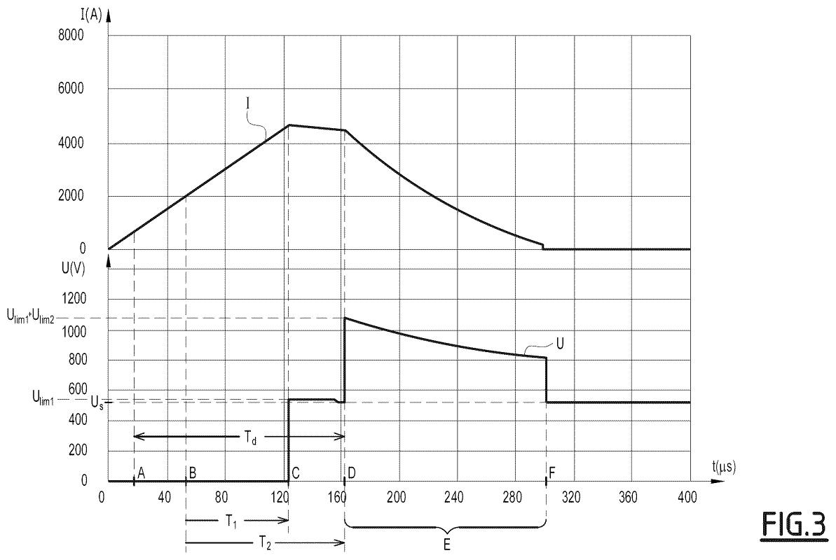

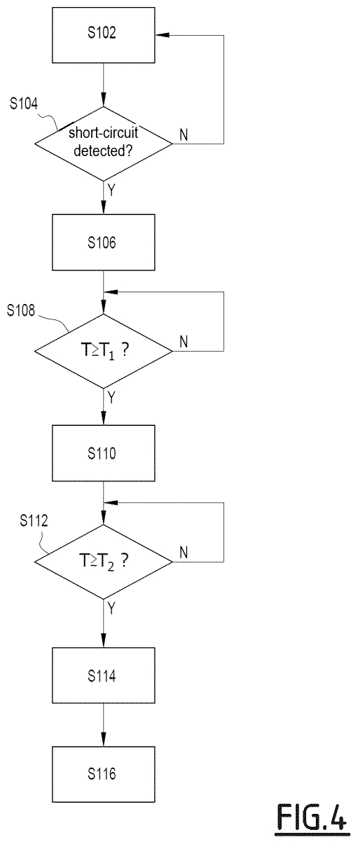

A method of operation of the device 10 will now be explained, with reference to FIGS. 3 and 4.

Initially, advantageously, the device 10 is in the armed configuration, meaning the disconnectors 23 and 24 are in the closed configuration, the mechanical switch 12 is in the closed configuration, and the transistors 34, 35, 44, and 45 are conducting. However, due to an internal resistance lower than that of the transistors 34, 35, 44, and 45, the mechanical switch 12 conducts the entire electrical current flowing in the device 10. A voltage U across the terminals of the device 10 is substantially zero.

The current sensor 52 measures the value I of the current flowing in the phase conductor 7, at step S102.

The control unit 60 receives the value I of the current measurement and detects, via the detection module 62, if a short-circuit is present between the source 3 and the load 5, at step S104. If a short-circuit is not detected, then the current sensor 52 performs step S102 again and continues to measure the value I of the current. An iterative operation is then implemented. If a short-circuit is detected, which corresponds to instant A in FIG. 3, then the control unit 60 commands the mechanical switch 12 to toggle to its open configuration, via the mechanical switch control module 64, at step S106. The opening of the mechanical switch 12 corresponds to instant B in FIG. 3.

When a short-circuit is present between the source 3 and the load 5, or in the load 5, the value I of the current increases significantly and rapidly, for example, by several tens of amperes per microsecond. Thus, the short-circuit is detected, for example, when the value I of the current is greater than a predetermined threshold, or when a derivative of the value of the current I is greater than a predetermined threshold, or when a combination of conditions on the value of the current I and its derivative are met.

When the mechanical switch 12 is in the open configuration, the electrical current is transferred from the mechanical switch 12 to the switching cell 18. However, the opening of the mechanical switch 12 generates an electric arc and ionization of the medium between the contacts of the mechanical switch 12. This decreases the dielectric strength of the mechanical switch 12. Thus, before reducing or interrupting the current flowing between the source 3 and the load 5, it is necessary to wait for a sufficient recovery of the dielectric strength of the mechanical switch 12, otherwise a re-strike may occur across the mechanical switch 12, meaning a re-ignition of the current through the contacts of the mechanical switch 12, while it is in the open configuration, and the reduction or interruption of the current cannot be achieved.

A waiting time T is measured from the moment the mechanical switch 12 toggles to the open configuration.

In an unrepresented variant, the waiting time T is measured from the moment the short-circuit is detected, in other words, from instant A.

When the waiting time T becomes greater than or equal to a first waiting threshold T1, also called Paschen time, the dielectric strength of the mechanical switch 12 is sufficient to withstand a voltage across the terminals thereof equal to the limiting voltage Uₗᵢₘ₁. The first waiting threshold T1 is advantageously predetermined and programmed by the manufacturer of the device 10 based on, for example, the characteristics of the mechanical switch 12 and the limiting voltage Uₗᵢₘ₁, or is determined by the control unit 60, for example, based on the value I of the current at the moment the mechanical switch 12 toggles to the open configuration and the limiting voltage Uₗᵢₘ₁.

The control unit 60 determines if the waiting time T is greater than or equal to the first waiting threshold T1, at step S108. If not, then the control unit 60 waits for a predetermined time and then performs step S108 again. If the waiting time T is greater than or equal to the first waiting threshold T1, then the cell control module 66 commands the switching module 32 to the blocking configuration at step S110, which corresponds to instant C in FIG. 3. The transistors 36 and 37 are blocked and do not conduct the current, which then flows through the voltage limiting element 39 and the switching module 42. The voltage U at the terminals of the device 10, and therefore across the terminals of the mechanical switch 12, is then equal to the limiting voltage Uₗᵢₘ₁. The passage of the current through the voltage limiting element 39 allows an increase in the value of the current I caused by the short-circuit to be limited, according to the following formula:

$$T A ≅ 1 - \frac{U}{{U}_{s}}$$

With TA the growth rate of the value of the current I;
U the voltage across the terminals of the device 10; and
Uₛ the nominal voltage of the current, also called mains voltage.

In practice, the voltages induced by the resistance of the conductors 7 and 8, and by the fault are considered negligible, and the growth rate TA is thus considered equal to

$$1 - \frac{U}{{U}_{s}} .$$

In FIG. 3, the limiting voltage Uₗᵢₘ₁ is approximately equal to the nominal voltage of the current Us, for example, on the order of 520V. Thus, when the switching module 32 is commanded to the blocking configuration, the voltage U across the terminals of the device 10 is on the order of 520V, and the value of the current I stops increasing.

The control unit 60 also determines if the waiting time T is greater than or equal to a second waiting threshold T2. The second waiting threshold T2 is also measured from the moment the mechanical switch 12 toggles to the open configuration and corresponds to the moment when the dielectric strength of the mechanical switch 12 is equal to the sum of the limiting voltages Uₗᵢₘ₁ and Uₗᵢₘ₂ of the switching modules 32 and 42.

Thus, the control unit 60 determines if the waiting time T is greater than or equal to the second waiting threshold T2, at step S112. If the waiting time T is less than the second waiting threshold T2, then the control unit 60 waits for a predetermined time and then performs step S112 again. An iterative operation is then implemented. If the waiting time T is greater than or equal to the second waiting threshold T2, then the cell control module 66 commands the switching module 42 to the blocking configuration at step S114, which corresponds to instant D in FIG. 3.

The second waiting threshold T2 is advantageously predetermined and programmed by the manufacturer of the device 10, for example, based on the characteristics of the mechanical switch 12 and the limiting voltage Uₗᵢₘ₂, or is determined by the control unit 60, for example, based on the value I of the current at the moment the mechanical switch 12 toggles to the open configuration, and the limiting voltage Uₗᵢₘ₂.

During step S114, the transistors 44 and 45 are blocked, in addition to the transistors 34 and 35. The current then passes through the voltage limiting element 39 and the voltage limiting element 49. The voltage U across the device 10 is therefore equal to the sum of the limiting voltages Uₗᵢₘ₁ and Uₗᵢₘ₂.

The voltage across the device 10 being greater than the network voltage, the value I of the current flowing in the device 10 decreases until it becomes zero, as visible in zone E in FIG. 3. When the value I of the current becomes zero, the current is interrupted between the source 3 and the load 5, and the voltage across the terminals of the device 10 becomes equal to the network voltage Uₛ, as visible at instant F. Advantageously, a tripping time Td between the moment the short-circuit is detected and the moment all switching modules have toggled to the blocking configuration, meaning a time between instants A and D, is less than 1 ms, preferably less than 400 μs, preferably even less than 200 μs.

Advantageously, when the value I of the current has become zero, the disconnector control module 68 activates the actuators 25 and 26, to toggle the disconnectors 23 and 24 to the open configuration at step S116. For example, in the case where the actuators 25 and 26 are coils, the disconnector control module 68 sends an electrical pulse to the actuators 25 and 26. This generates a magnetic field that interacts with the disconnectors 23 and 24 and allows them to toggle to the open configuration. The device 10 is then in the tripped configuration.

The disconnectors 23 and 24 toggle to the open configuration only once the current is cut-off and serve to galvanically isolate the source 3 and the load 5, but do not participate in the cutting-off of the current as such.

More generally, in the case where the device 10 comprises other switching modules, each waiting threshold is determined based on the switching module and the order in which the switching modules toggle to the blocking configuration. Indeed, a given switching module is commanded to open when the waiting time T is greater than or equal to the time required for the dielectric strength to become greater than or equal to the sum of the limiting voltage of the given switching module and the limiting voltages of the switching modules already in the blocking configuration.

The process is described in the case where the switching module 32 is commanded before the switching module 42. Alternatively, it is the switching module 42 that is commanded before the switching module 32. In this case, the first waiting threshold is calculated based on the dielectric strength required to withstand the limiting voltage Uₗᵢₘ₂ without breakdown of the mechanical switch 12, in other words, based on the limiting voltage Uₗᵢₘ₂.

The successive command of the switching modules 32 and 42 thus allows the current to be limited earlier, in this case as soon as the first waiting threshold T1 is reached, rather than waiting for the second waiting threshold T2 to be reached before cutting-off the current, and allowing the value I of the current to increase as long as the second waiting threshold T2 is not elapsed. This notably allows the increase in the value I of the current to be limited avoiding overheating of the conductors 7 and 8, and also transistors 34, 35, 44, and 45 to be chosen whose current rating is lower than for an equivalent device without switching modules successively commanded to the blocking configuration.

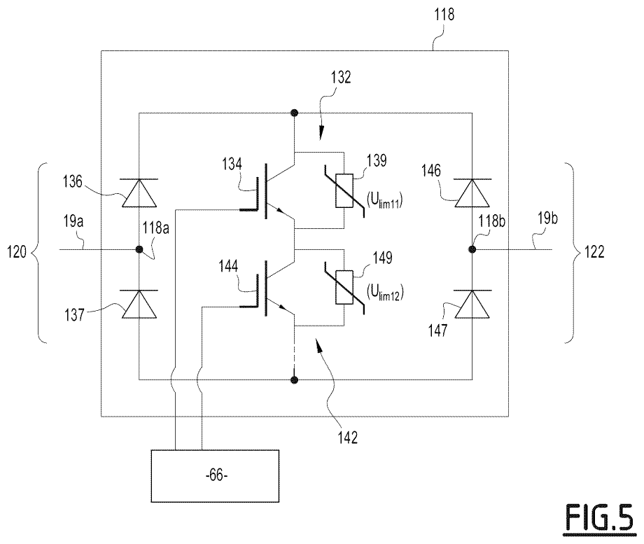

FIG. 5 is a diagram of a switching cell 118 of an electrical protection device 10 according to a second embodiment of the invention, as a variant to the switching cell 18. The switching cell 118 is, similarly to the switching cell 18, connected in parallel with the mechanical switch 12, such that the input 12a and the output 12b of the mechanical switch 12 are connected respectively to an input 118a and an output 118b of the switching cell 118. More specifically, the input 12a of the mechanical switch 12 and the input 118a of the switching cell 118 are connected by the non-switchable electrical connection 19a, and the output 12b of the mechanical switch 12 is connected to the output 118b of the switching cell 118 by the non-switchable electrical connection 19b. The switching cell 118 comprises two rectifying branches 120 and 122. Each rectifying branch 120 and 122 comprises two diodes, 136 and 137 for the rectifying branch 120 and 146 and 147 for the rectifying branch 122 respectively. The diodes 136 and 137 are connected in anti-series with respect to each other, meaning the diodes 136 and 137 are connected in series and never conduct the current simultaneously. The same applies to the diodes 146 and 147.

The input 118a and the output 118b of the switching cell 118 correspond to the midpoint of the rectifying branch 120, between the diodes 136 and 137, and the midpoint of the rectifying branch 122, between the diodes 146 and 147 respectively. Thus, the switching cell 118 is connected in parallel with the mechanical switch 12 by the midpoint of each rectifying branch 120 and 122.

The switching cell 118 comprises two switching modules 132 and 142, but, in an unrepresented variant, comprises more than two switching modules. The switching modules 132 and 142 are connected in parallel with the rectifying branches 120 and 122 and in series with each other. Alternatively, the switching cell 118 comprises more than two switching modules, connected in series with the switching module 142 and in parallel with the branches 120 and 122.

The switching modules 132 and 142 respectively comprise a switchable semiconductor element, which here are a transistor 134 and 144, and a voltage limiting element 139 and 149. The voltage limiting element 139 is connected in parallel with the transistor 134, and the voltage limiting element 149 is connected in parallel with the transistor 144. The transistors 134 and 144 are in the example of FIG. 5, unidirectional current transistors, whose direction is indicated by an arrow on each transistor. The voltage limiting elements 139 and 149 are similar, at least functionally, to the voltage limiting elements 39 and 49 and have a limiting voltage Uₗᵢₘ₁ and Uₗᵢₘ₁₂ respectively. The limiting voltage Uₗᵢₘ₁ is advantageously different from the limiting voltage Uₗᵢₘ₁₂, but alternatively, these voltages are identical.

The switching cell 118 is configured to be independent of the current flow direction by means of the diodes 136, 137, 146, and 147, so that the unidirectional switching modules 132 and 142 can be used bidirectionally. The arrangement of the diodes 136, 137, 146, and 147 allows the number of diodes in the switching cell 118 to be limited to four. Thus, even when the switching cell 118 comprises more than two switching modules, only the four diodes 136, 137, 146, and 147 are necessary for their operation, thus limiting the number of diodes required compared to the switching cell 18.

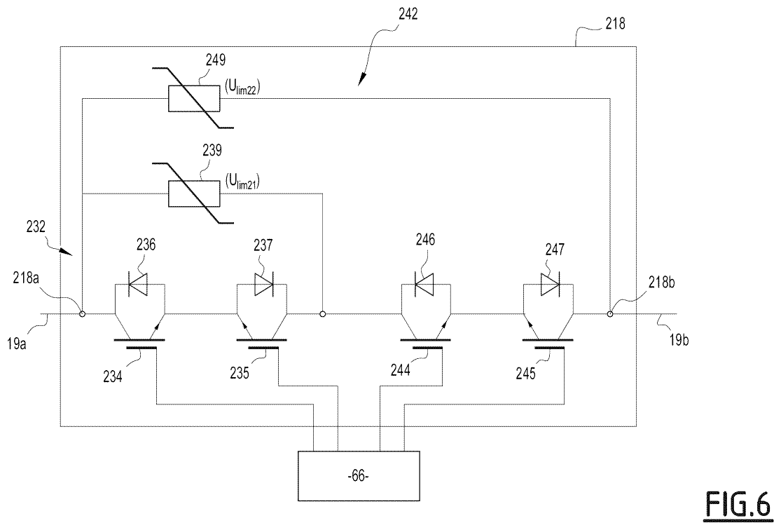

FIG. 6 is an electrical diagram of a switching cell 218 of an electrical protection device 10 according to a third embodiment of the invention, as an alternative embodiment of the switching cells 18 and 118.

The switching cell 218 comprises an input 218a and an output 218b and is connected in parallel with the mechanical switch 12, such that the input 12a and the output 12b of the mechanical switch 12 are connected to the input 118a and the output 118b respectively of the switching cell 118. More specifically, the input 12a of the mechanical switch 12 and the input 218a of the switching cell 218 are connected by the non-switchable electrical connection 19a, and the output 12b of the mechanical switch 12 is connected to the output 118b of the switching cell 118 by the electrical connection 19b.

The switching cell 218 comprises two switching modules 232 and 242. The switching module 232 is similar to the switching module 32 and comprises two semiconductor elements, here two transistors 234, 235 connected to each other in anti-series, which are advantageously unidirectional in current, as indicated by an arrow on each transistor 234, 235. The switching module 232 comprises a diode 236, connected in anti-parallel with the transistor 234, and a diode 237 connected in anti-parallel with the transistor 235. The switching module 232 comprises a voltage limiting element 239, similar at least functionally to the voltage limiting element 39, with a limiting voltage Uₗᵢₘ₂₁, and connected in parallel with a set formed by the transistors 234 and 235.

The switching module 242 also comprises two transistors 244 and 245, connected in anti-series with each other, which are advantageously unidirectional in current, as indicated by an arrow on each transistor 244, 245. A diode 246 is connected in anti-parallel with the transistor 244, and a diode 247 is connected in anti-parallel with the transistor 245. The switching module 242 comprises a voltage limiting element 249, similar at least functionally to the voltage limiting element 49, with a limiting voltage Uₗᵢₘ₂₂. The limiting voltage Uₗᵢₘ₂₂ is advantageously different from the limiting voltage Uₗᵢₘ₂₁, but alternatively, the limiting voltages Uₗᵢₘ₂₁ and Uₗᵢₘ₂₂ are identical.

In the conducting configuration, when the current passing through the device 10 is alternating, the current flows successively through the transistor 234, the diode 237, the transistor 244, and the diode 247 on the one hand, then when the current changes direction, through the transistor 235, the diode 236, the transistor 245, and the diode 246 on the other hand.

Unlike the voltage limiting element 49, the voltage limiting element 249 is connected in parallel with a set formed by the four transistors 234, 235, 244, and 245. Thus, the switching modules 232 and 242 are not connected in series with each other.

The operating method described for a device 10 comprising a switching cell 18 is also applicable to a device 10 comprising a switching cell 118 or a device 10 comprising a switching cell 218.

The switching cell 218 allows, when the switching module 232 is the only one commanded to the blocking configuration, a voltage to be obtained across terminals of the device 10 equal to the limiting voltage of the voltage limiting element 239. When the switching module 242 is switched to the blocking configuration, independently of the command of the switching module 232, the voltage across the terminals of the device 10 is equal to the voltage of the voltage limiting element 249. Thus, the limiting voltages across the terminals of the device 10 can be Uₗᵢₘ₂₁ or Uₗᵢₘ₂₂. In an unrepresented variant, the source 3 and the load 5 are connected by a single phase conductor, or by a plurality of phase conductors, for example, three. In this case, the device 10 advantageously comprises, for each phase conductor, a mechanical switch and a switching cell connected in parallel with the mechanical switch.

Optionally, a mechanical switch is connected to the neutral conductor, with a switching cell connected in parallel with the mechanical switch.

In an unrepresented variant, the source 3 and the load 5 are connected only by one, possibly a plurality of phase conductors, and/or the electrical installation 1 does not comprise a neutral conductor 8.

1. An electrical protection device, configured to be connected between a source and a load, the device comprising:
a mechanical switch, configured to toggle between a closed configuration, wherein the mechanical switch conducts a current flowing between the source and the load, and an open configuration, wherein the mechanical switch does not conduct the current;
a switching cell, connected in parallel with the mechanical switch, the switching cell comprising a plurality of switching modules, connected to each other, each switching module comprising:
at least one semiconductor element; and
a voltage limiting element, connected in parallel with each semiconductor element,
each switching module having a limiting voltage, each switching module being configured to toggle between a conducting configuration, wherein the current flows through one or each of the semiconductor elements of the switching module, and a blocking configuration, wherein if the current flows through the switching module, the current flows through the voltage limiting element;
a current sensor configured to measure a value of the current;
a control unit comprising:
a detection module configured to detect a short-circuit type electrical fault based on the value of the current measured by the current sensor;
a mechanical switch control module, configured to command the mechanical switch to the open configuration when a short-circuit type electrical fault is detected; and
a cell control module, configured to successively switch each switching module to the blocking configuration, one of the switching modules being commanded from the conducting configuration to the blocking configuration when a dielectric strength of the mechanical switch is greater than or equal to a sum of the limiting voltage of said switching module and the limiting voltages of the switching modules in the blocking configuration,
wherein an input of the mechanical switch and an input of the switching cell are connected to each other by a non-switchable electrical connection and an output of the mechanical switch and an output of the switching cell are connected to each other by a non-switchable electrical connection.

2. The device according to claim 1 wherein the switching modules are connected in series with each other.

3. The device according to claim 2 wherein each switching module comprises two semiconductor elements that are unidirectional in current and connected to each other in anti-series, and for each semiconductor element, a diode is connected in anti-parallel with the semiconductor element.

4. The device according to claim 2 wherein:
the switching cell comprises two rectifying branches, the input and the output of the switching cell forming a midpoint of one of the rectifying branches respectively, each rectifying branch comprising two diodes arranged on either side of the midpoint, connected in anti-series with respect to each other;
the switching modules are connected in parallel with the rectifying branches; and
each switching module comprises a single semiconductor element connected in parallel with the voltage limiting element.

5. The device according to claim 4, comprising at least three switching modules.

6. The device according to claim 1, further comprising a disconnector, connected in series with the mechanical switch without being connected in parallel with the switching cell.

7. The device according to claim 1, wherein a tripping time between the detection of the short-circuit type electrical fault by the detection module and a transition of all switching modules to the blocking configuration is less than 1 ms.

8. The device according to claim 1, wherein a tripping time between the detection of the short-circuit type electrical fault by the detection module and a transition of all switching modules to the blocking configuration is less than 400 μs.

9. The device according to claim 1, wherein a tripping time between the detection of the short-circuit type electrical fault by the detection module and a transition of all switching modules to the blocking configuration is less than 200 μs.

10. An electrical installation comprising a source, a load connected to the source, and an electrical protection device according to claim 1, connected between the source and the load, with a nominal voltage of the current flowing between the source and the load being less than 1500 V.

11. A method for controlling an electrical protection device, the electrical protection device being according to claim 1, the method comprising at least the following steps:
measurement of the value of the current by the current sensor;
detection of a short-circuit type electrical fault by the control unit, based on the value of the current measured by the current sensor;
when a short-circuit type electrical fault is detected, commanding the mechanical switch to the open configuration by the mechanical switch control module; and
successively commanding each switching module to the blocking configuration, one of the switching modules being commanded from the conducting configuration to the blocking configuration when a dielectric strength of the mechanical switch is greater than or equal to the sum of the limiting voltage of said switching module and the limiting voltages of the switching modules in the blocking configuration.
